(19) United States
(12) Patent Application Publication
(10) Pub. No.: US 2020/0380607 A1
(43) Pub. Date: Dec. 3, 2020

(54) GAP INSURANCE COVERAGE

(71) Applicant: PETER T. FRODIGH, Westwood, MA (US)

(72) Inventor: PETER T. FRODIGH, Westwood, MA (US)

(21) Appl. No.: 16/996,359

(22) Filed: Aug. 18, 2020

Related U.S. Application Data
(63) Continuation of application No. 16/554,353, filed on Aug. 28, 2019, now abandoned.
(60) Provisional application No. 62/723,671, filed on Aug. 28, 2018.

(51) Int. Cl. G06Q 40/08; G07C 5/08; G06Q 30/02

(52) U.S. Cl. CPC G06Q 40/08; G06Q 30/0278; G07C 5/0841

(57) ABSTRACT

A method for ascertaining a loss of value for a vehicle includes collecting data regarding vehicle maintenance, damages and other factors that may effect the value of a vehicle. The data are evaluated for ascertaining an average change in value of a vehicle as a result of changes of the factors. The value of the vehicle having an average change in value is compared with a comparable vehicle not having sustained damage. An average difference is determined. The average difference is used to price an insurance policy for the loss of value for a vehicle having been damaged and then repaired as compared to an undamaged vehicle.

### RELATED APPLICATION(S)

This application is a continuation of U.S. application Ser. No. 16/554,353, filed on 28 Aug. 2019, which claims the benefit of U.S. Provisional Application No. 62/723,671, filed on 28 Aug. 2018, the contents of which are both incorporated herein by reference in their entirety.

### BACKGROUND

Individual owners, and lease companies, are exposed to significant depreciation in the event their vehicle(s) become damaged. Assuming the vehicle is insured, the damage can be repaired so the vehicle is once again roadworthy. However, while the repair may make the vehicle operable, the vehicle will likely suffer a meaningful decrease in value because it is now “branded” as a damaged vehicle by the likes of CarFax and other vehicle database companies.

### SUMMARY OF DISCLOSURE

The features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Offer an insurance option that will provide coverage (partial or total) for a vehicle that may be involved in an accident in the future. This insurance coverage can be thought of as “gap” insurance—coverage that will help defray the lost value a vehicle may be subject to in the event of an accident.

Vehicle database companies, such as CarFax, archive records of vehicle maintenance, damage, transfer of ownership, annual vehicle inspection, etc., and make these records available to interested parties for a fee. When a vehicle becomes “branded” with a CarFax record of damage resulting from an accident, the vehicle's value decreases significantly since future buyers will opt to buy similar vehicles without previous damage. (Collectable vehicles and/or rare vehicles lose significant desirability if they are no longer in pristine, original and unmolested condition.) Individual owners and lease companies may own vehicles that have become damaged during the tenure of their ownership, and then later restored as closely as possible to their original condition. They may be shocked to find the value of their vehicle is nowhere near the book values portrayed by valuation companies such as Kelley Blue Book, NADA, Edmunds, Black Book, etc., because of the damage to their asset. Whether the vehicle is sold on the secondary market, traded in, or sold on the wholesale auction block, buyers are only willing to pay a fraction of the stated book value. If the vehicle was/is owned as an investment, the damaged vehicle will no longer carry the pre-damaged asset value on the owner's balance sheet.

The buyer of the aforementioned insurance protection could, for example, pay an annual premium to “lay-off” the liability exposure of a potential asset-depreciating vehicle damage. Several ranges of coverage could be offered based on the severity of potential damage, vehicle value and potential post-damage depreciation, and potentially offer an option that considers the time expiration from when the vehicle was produced. The time frame from original production could potentially be accretive to asset value, or it could accelerate asset depreciation, based on the desirability of the vehicle in question.

The insurance company would need to research a broad spectrum of vehicle damage history to determine premium values that make sense for the vehicle owner, while providing profitability for the insurance company and an incentive for the ultimate seller of the coverage.

The purchase of Damaged Vehicle Depreciation Insurance (DVDI) could potentially occur within a specific time period after original purchase (either new or used vehicles could qualify), and could potentially be sold by a trained representative, or at the Financing and Insurance Department of a franchised car dealership.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

While this invention has been particularly shown and described with references to preferred embodiments thereof, it will be understood by those skilled in the art that various changes in form and details may be made therein without departing from the scope of the invention encompassed.

What is claimed is:

1. A method for ascertaining a loss of value for a vehicle, comprising:
collecting data regarding vehicle maintenance, damages and other factors that may effect the value of a vehicle;
evaluating said data for ascertaining an average change in value of a vehicle as a result of changes of the factors;
comparing the value of the vehicle having an average change in value with a comparable vehicle not having sustained damage; and
determining an average difference.

2. The method of claim 1 wherein the average difference is used to price an insurance policy for the loss of value for a vehicle having been damaged and then repaired as compared to an undamaged vehicle.
